(19) United States
(12) Patent Application Publication
(10) Pub. No.: US 2018/0303081 A1
(43) Pub. Date: Oct. 25, 2018

(54) NOZZLE ASSEMBLY FOR A SPRAY DEVICE FOR THE TREATMENT OF CROPS WITH A JET STOP DETECTION

(71) Applicant: EXEL INDUSTRIES, PARIS (FR)

(72) Inventor: Fabien CHAPERON, Paris (FR)

(73) Assignee: EXEL INDUSTRIES, PARIS (FR)

(21) Appl. No.: 15/955,872

(22) Filed: Apr. 18, 2018

(30) Foreign Application Priority Data
Apr. 19, 2017 (FR) 17/53372

(51) Int. Cl. A01M 7/00

(52) U.S. Cl. CPC A01M 7/0042; B05B 1/10; A01M 7/006; A01M 7/0014

(57) ABSTRACT

The present disclosure provides a nozzle assembly for a spray device for the treatment of agricultural crops and includes at least one orifice for dispensing at least one treatment product. The nozzle assembly further includes, downstream of the orifice, at least one set of electrodes configured to pass an electrical signal when humidified under the effect of the spray jet. The electrodes are configured to be connected to an electronic system for detecting the electrical signal.

### CROSS-REFERENCE TO RELATED APPLICATIONS

This application claims priority to and the benefit of FR 17/53372 filed on Apr. 19, 2017. The disclosure of the above application is incorporated herein by reference.

### FIELD

The present disclosure relates to a nozzle assembly for a spray device for the treatment of agricultural crops.

### BACKGROUND

The statements in this section merely provide background information related to the present disclosure and may not constitute prior art.

Some types of crops, including vines or fruit tree plantations, require the spraying of treatment products which are generally made by the passage of an agricultural tractor between the rows of these plants, towing a spray facility including bars equipped with series of nozzles powered by a pump linked to a tank containing the product.

The treatment product may have different consistencies. The spray nozzles of the product includes calibrated bores of relatively small diameters, but with sufficiently thick treatment products, particularly for vine treatment slurries, a nozzle clogging can occur.

In the case of a sprayer provided for trees, the tractor generally moves forward between two rows of trees with a lateral spray on each side on the trees.

If the spray jets are not too far from the driver and if the lighting is sufficient, these jets may remain visible to the driver present in the tractor cabin. He may notice the absence of some jets caused by the clogging of their nozzle.

In the case of a treatment at height, for example for high fruit hedges, the spray nozzles are installed higher. Depending on the configuration of the tractor, the spray jets can be hardly visible to the driver.

In the case of a sprayer provided for vines, several configurations of the bars exist. The rows of vines can be treated on top with a bar passing above. In this case, the tractor driver can generally keep a view on the spray jets to monitor their operation.

Alternatively, the rows may be treated on the sides with a transverse bar spanning several rows, and nozzles going down between each space between two rows to treat the sides of these rows by lateral spray. In this case, bars that can span up to eight rows can be made. Depending on the extent of the vegetation, a direct view by the driver from the tractor cabin may be impossible.

In all cases, a direct monitoring of the spray jets by the driver during work requires some attention that is tiring and that can disrupt him when driving his machine.

Moreover, when the driver notices an absence of a jet, if his monitoring is not constant, he does not know since when the treatment has stopped, which can affect the quality of the treatment of the plot.

If the view of the operator on the jets is not possible in the rows of plantations, he can notice an absence of jets at each end of the rows in the case where he carries on the spraying while leaving these rows to monitor this spraying. A disadvantage is that we do not know when the jet has stopped. There is also some waste of the treatment product projected out of the rows.

In addition, this possibility is not practicable for systems cutting automatically the spraying at the end of the rows to avoid this waste. In this case, the operator will discover the clogging of nozzles only at the end of the work site when cleaning his sprayer, without knowing when the treatment has stopped.

In order to limit the issues of clogging of the nozzles, it is possible to provide for slurry preparations having sufficient dispersion of the solid particles in water and maintenance of this dispersion.

Filters disposed in the product supply circuit may also be provided, which retain the large solid particles or the residual clusters before reaching the nozzles.

Finally, it is possible to provide for specific cycles of rinsing and cleaning the sprayer at the end of the work to eliminate any risk of sedimentation of solid particles in different parts of the facility after the end of a work site.

For these solutions, it is necessary to provide for specific treatment products that can be more expensive, filters that are fine enough not to let all the products pass and that require a maintenance, or to increase the labor time with the particular cleaning cycles.

### SUMMARY

The present disclosure provides a nozzle assembly for a spray device for the treatment of agricultural crops, including at least one orifice for dispensing at least one treatment product. This nozzle assembly includes, downstream of the orifice, at least one set of electrodes configured to emit an electrical signal when the electrodes are humidified under the effect of the spray jet. The electrodes are intended to be connected to an electronic system for detecting the electrical signal. In the context of the present disclosure, the term “downstream” should be understood in relation to the direction of flow of the treatment product, when the nozzle assembly is in operation.

The treatment product is a fluid product, which may be in the form of a fluid and/or gas.

By spraying, it is understood that the treatment product is atomized in the form of drop and may be in the form of droplets.

An advantage of the nozzle assembly is that, by measuring the resistivity between two electrodes, in case of outflow of the treatment product jet coming from the dispensing orifice, a humidification of the surfaces between these electrodes which will give a lower resistivity is obtained.

In case of absence of outflow of the treatment product, in particular because of a clogging of the dispensing orifice, a drying of the electrodes is obtained, which can be done naturally over time, or more rapidly by an air jet or by other means such as an infrared heater. There is then an increase in the resistivity between the electrodes which allows sending a signal to the driver indicating a failure in the nozzle assembly.

Without requiring particular attention from the driver and regardless of the type of crop and treatment, the driver can be informed of the failure. The driver can then intervene, which provides safe driving of the tractor, quality and speed of work, and decreased waste products.

The nozzle assembly according to the present disclosure may further include one or more of the following features, which may be combined with each other.

In one form, the nozzle assembly includes two electrodes comprising parallel strips which are interposed from one electrode to the other. Large surfaces opposite each other are obtained in a simple manner.

These electrodes are disposed to present the maximum points of proximity therebetween.

These electrodes can be two fine combs intersecting without contact.

These electrodes may have the thinnest possible pin thickness while remaining rigid so as to form a wall with a hole at least at 50% in order to provide its passage through the spray jet.

According to one form, the electrodes are formed on a printed circuit. This means is cost-effective.

According to another form, the electrodes constitute a metal comb disposed substantially in a plane perpendicular to the spray jet.

In this case, the comb is integrated by overmolding in a support. This overmolding method is cost-effective.

In one form, the nozzle assembly includes a control system linked to the set of electrodes, measuring the current flowing in these electrodes.

In this case, the control system can individually measure the current flowing in a specific set of electrodes for a nozzle assembly. The driver of the concerned nozzle assembly can be warned of a failure.

The electrodes may be composed of a material having antioxidant properties compared to the treatment products used.

The electrodes can be made of a material having an electrical conductivity of at least 1.3×10E6 Siemens/m.

One of the two electrodes can be electrically powered by a voltage comprised between 5 Vdc and 15 Vdc.

The nozzle assembly can include an electronic system for detecting a presence of threshold voltage on the other electrode by measuring an electric current flowing between the electrodes of at least 50 μA.

The electronic system may have a device for adjusting the threshold voltage to be detected. In addition, the nozzle assembly may include a drying device for drying the set of electrodes. Thus, improving the detection of the failure.

The drying device may include a pressurized air jet.

Alternatively, the drying device can provide a supply of calories.

The present disclosure also relates to a spray device comprising at least one nozzle assembly in accordance with the above.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side axial sectional view of a nozzle assembly with pneumatic jet according to the present disclosure;

FIG. 2 is a top axial sectional view of the nozzle assembly with pneumatic jet according to the present disclosure;

FIG. 3 shows a type of electrode disposed on a spark gap of the nozzle assembly according to the present disclosure;

FIG. 4 shows another type of electrode disposed on a spark gap of a nozzle assembly with pneumatic jet according to the present disclosure;

FIG. 5 is a top axial sectional view of a nozzle assembly with pneumatic jet including an electrode according to the present disclosure;

FIG. 6 is a diagram showing a front view of electrodes according to the present disclosure;

FIG. 7 is a side axial sectional view of a nozzle assembly with an air-assisted spray according to the present disclosure;

FIG. 8 is a side axial sectional view of a nozzle assembly with a non-air assisted spray according to the present disclosure; and

FIG. 9 shows an agricultural vehicle equipped with a spray bar including a nozzle assembly according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

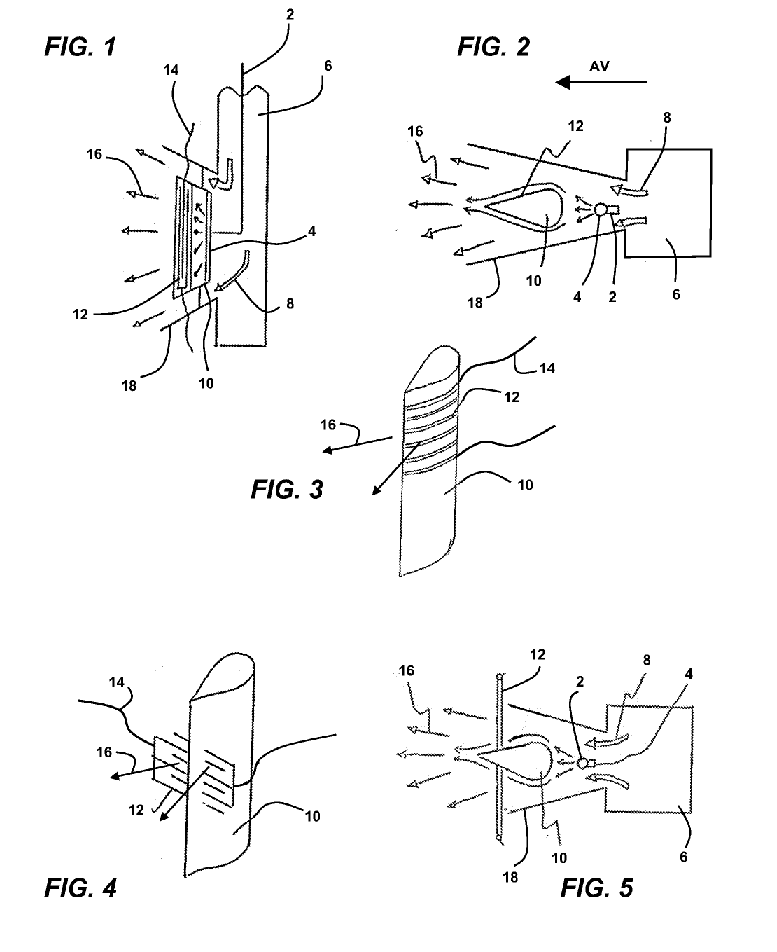

FIGS. 1, 2 and 3 show a nozzle assembly including a treatment product inlet 2 disposed in the center of a pressurized air inlet 6, at the end of a pipe, opening onto a plurality of treatment product dispensing orifices 4 extending in the vertical direction.

The direction called “vertical direction”, can be for the treatments disposed according to all orientations. The spraying is done in a forward direction indicated by the arrow “AV.”

The pressurized air forms a flow 8 coming on the sides of the orifices 4, which is guided laterally by an air diffuser 18 of generally conical shape opening toward the front. The air flow 8 drives the product to carry it on a spark gap 10. The spark gap 10 has an aerodynamically-shaped horizontal section, comprising a curved rear portion and a pointed front portion. The curved rear portion may also be designated as a leading edge of the treatment product and the front portion as a trailing edge of this treatment product.

In contact with the spark gap 10, the product droplets burst and disperse to form a fine spray which gives the pneumatic jet 16 evenly dispersed throughout the arc formed by the air diffuser 18. By adjusting the aerodynamic profile of the spark gap 10 and the opening of the air diffuser 18, a spray jet 16 is carried out including a suitable opening angle, performing a homogeneous treatment over the entire covered surface.

The spark gap 10 includes two electrodes 12 bonded onto its surface, each including a set of strips disposed in parallel and evenly spaced, receiving between two strips, a strip of the other electrode.

Each electrode 12 includes a power supply wire 14 which is connected to a control system onboard the vehicle. The control system applies a differential voltage onto the pair of electrodes 12, and measures the current flowing between these two electrodes.

Particularly, the electrodes 12 may be formed by a printed circuit including an insulating flexible support having conductive strips fixed thereto, which is wound and bonded onto the spark gap 10.

The distance between the strips of each electrode may be comprised between 0.5 mm and 5 mm, and particularly between 0.5 and 1.5 mm. During a spraying, the water contained in the spray product humidifies the electrodes 12. A certain conductivity is obtained between the parallel strips of the electrodes 12, which allows the current to flow between these two electrodes.

If the nozzle assembly gets clogged, or if for any other reason the treatment product no longer flows out of the orifices 4, there is then only the air flow 8 that dries very quickly the surface of the spark gap 10. The conductivity between the two electrodes 12 decreases sharply, the decrease of the current flowing in these electrodes is measured by the control system that alerts the driver by any means such as an indicator light or a sound signal.

The control system can measure in an undifferentiated manner the current flowing in the electrodes of all the nozzles of the spray facility, which allows it to report a defect without being able to specify the ineffective nozzle. Alternatively, the control system can measure in a particular way the current flowing in each pair of electrodes, which allows it to report the ineffective nozzle assembly.

In addition, any other connection means between the control system and the electrodes 12 of the different sets of nozzles may be used, such as a wireless connection or a multiplexed array.

FIGS. 4 and 5 show a pair of electrodes 12 forming a rigid metal comb disposed in a vertical plane perpendicular to the spray jet 16, comprising the alternating strips of each electrode disposed horizontally. Each side of the comb includes an electric wire 14 connected to an electrode 12, for the connection with the control system.

The comb is inserted into the spark gap 10 a little before its end tip, so as to have its two sides opposite the spray jet 16 passing therethrough. Particularly, the spark gap 10 can be made by overmolding a plastic material around the comb.

In the same manner, the spray jet 16 humidifies the surfaces of the electrodes 12 thereby performing an electrical conduction therebetween.

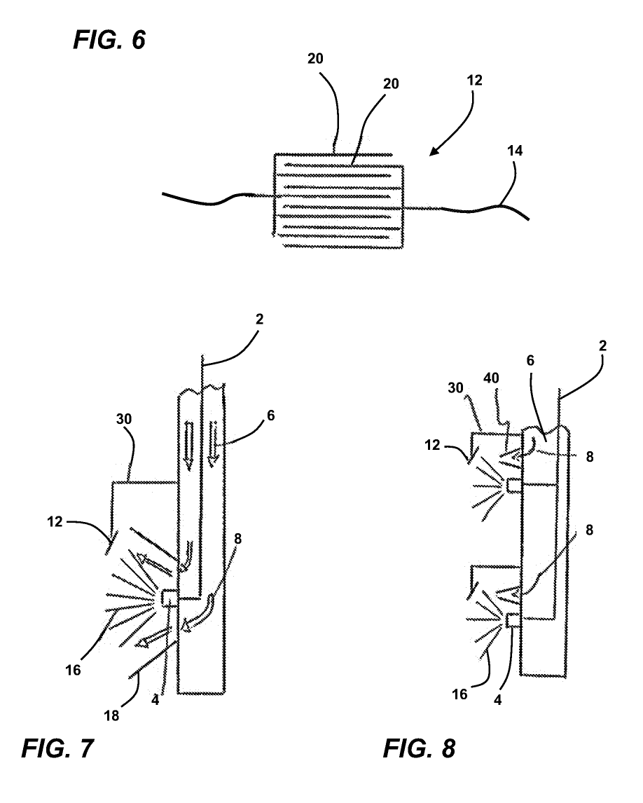

FIG. 6 shows a comb forming the electrodes 12. The number of horizontal strips 20, their lengths and their spacings define, with the presence of humidity, an electrical conduction capacity which is calculated to allow a dry resistivity variation that is easily measurable by the control system.

FIG. 7 shows a nozzle assembly for an air-assisted spray. The air flow 8 guided by the diverging air diffuser 18 takes the treatment product flowing out of this nozzle in the form of very fine droplets in order to form the spray jet 16.

In this case a support 30 is disposed which supports a pair of electrodes 12 formed on one side of the spray jet 16 to reduce disturbance to the jet.

In the same manner, the spray jet 16 humidifies the surface of the electrodes 12, which is measured by the control system to detect that the treatment product has stopped.

FIG. 8 shows a nozzle assembly comprising several dispensing orifices 4 disposed in parallel for a non-air assisted spray, which receive the treatment product with a sufficient pressure to directly produce, without an additional air jet, the bursting of this product at the outlet of these orifices, and the projection of spray jets 16.

As for the air-assisted spray shown in FIG. 7, a support 30 receiving a pair of electrodes 12 is disposed in front of each orifice 4 to detect the absence of outflow of the product through this orifice.

In addition, a small pressurized air jet injector 40 giving a small air flow rate directed directly onto the electrodes is added opposite each pair of electrodes 12, in order to dry them rapidly in case the treatment product stops to flow. In this manner, a rapid drying of the electrodes 12 allowing to report without delay to the driver the clogging of the nozzles 4 is obtained with a low consumption of pressurized air.

Alternatively, any other rapid drying system of the electrodes 12 may be disposed, in particular by a supply of calories, for example with an infrared radiant system.

In general, reliable detection is obtained in a simple, cost-effective and efficient manner, allowing to detect very quickly that a spray jet has stopped, which does not require a particular attention for the driver.

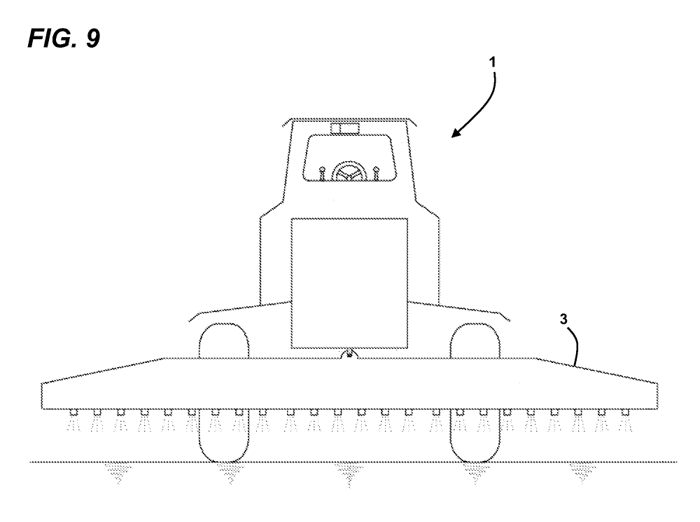

FIG. 9 illustrates an agricultural vehicle 1, such as an agricultural tractor, equipped with a device for spraying the treatment product 2. The spray device is a spray bar 3 of the treatment product 2. The spray bar 3 includes the nozzle assembly as described above. Without this being restrictive, the spray bar 3 is provided to pass over the rows of plantations and thus treat these rows from above. Alternatively, such a spray bar 3 may be a lateral bar provided to extend laterally with respect to the agricultural vehicle 1 in order to span several rows of plantations.

Of course, the present disclosure is not limited to the various forms described and represented.

Thus, the electrodes could be integrated with other portions of the nozzle assembly, such as the wall of the diffuser 18

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A nozzle assembly for a spray device for the treatment of agricultural crops, the nozzle assembly comprising:
at least one orifice for dispensing at least one treatment product; and
at least one set of electrodes downstream of the at least one orifice, wherein the at least one set of electrodes are configured to emit an electrical signal when humidified as a result of an effect of a spray jet, and the at least one set of electrodes are configured to connect to an electronic system for detecting the electrical signal.

2. The nozzle assembly according to claim 1, wherein the at least one set of electrodes are disposed substantially in a direction of a flow of the spray jet.

3. The nozzle assembly according to claim 1, wherein the at least one set of electrodes are disposed substantially perpendicular to a flow of the spray jet.

4. The nozzle assembly according to claim 1, wherein at least two electrodes are disposed at a distance having maximum points of proximity.

5. The nozzle assembly according to claim 4, wherein one of the two electrodes is electrically powered by a voltage comprised between 5 Vdc and 15 Vdc.

6. The nozzle assembly according to claim 5 further comprising an electronic system for detecting a presence of a threshold voltage on the other electrode by measuring an electric current flowing between the electrodes of at least 50 pA.

7. The nozzle assembly according to claim 6, wherein the electronic system includes a device for adjusting the threshold voltage to be detected.

8. The nozzle assembly according to claim 1, wherein the at least one set of electrodes are formed as a printed circuit.

9. The nozzle assembly according to claim 1, wherein the at least one set of electrodes are two fine combs intersecting without contact.

10. The nozzle assembly according to claim 9, wherein the comb-shaped electrodes define a thinnest pin thickness while remaining rigid to form a wall having a hole of at least at 50% to provide passage through the spray jet.

11. The nozzle assembly according to claim 9, wherein the combs are integrated by overmolding in a support.

12. The nozzle assembly according to claim 11, wherein the combs form an integral part of the nozzle assembly.

13. The nozzle assembly according to claim 1, wherein the at least one set of electrodes are composed of a material having antioxidant properties relative to the treatment product.

14. The nozzle assembly according to claim 1, wherein the at least one set of electrodes are composed of a material having an electrical conductivity of at least 1.3×10E6 Siemens/m.

15. The nozzle assembly according to claim 1 further comprising a drying device for drying the at least one set of set of electrodes.

16. The nozzle assembly according to claim 15, wherein the drying device includes a pressurized air jet.

17. The nozzle assembly according to claim 15, wherein the drying device provides a supply of calories.

18. A spray device comprising at least one nozzle assembly according to claim 1.
